(19) United States
(12) Patent Application Publication
(10) Pub. No.: US 2006/0065483 A1
(43) Pub. Date: Mar. 30, 2006

(54) Baffle with flow-through medium

(75) Inventor: Matthew Thomas, Almont, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/238,817

(22) Filed: Sep. 29, 2005

Related U.S. Application Data
(60) Provisional application No. 60/614,341, filed on Sep. 29, 2004.

(51) Int. Cl. E04B 1/82; B64F 1/26

(52) U.S. Cl. 181/293; 181/286; 181/210

(57) ABSTRACT

There is disclosed a baffle having a medium that allows a fluid such as air to flow therethrough.

### PRIORITY CLAIM

The present application claims the benefit of U.S. Provisional Application Ser. No. 60/614,341 filed Sep. 29, 2004.

### FIELD OF THE INVENTION

The present invention relates generally to a baffle having a medium that allows a fluid such as air to flow therethrough.

### BACKGROUND OF THE INVENTION

For many years, industry (e.g., the transportation industry) has been concerned with designing baffles for limiting the transfer of sound to certain locations such as the passenger compartment of an automotive vehicle. More recently, it has been found that, in certain instances, it can be desirable for these baffles to allow a fluid such as air to flow through the baffle while still maintaining the ability of the baffle to limit sound transfer. For example, it may be desirable for air to flow through a baffle in order to relieve elevated air pressure in a passenger compartment of an automotive vehicle for instance, when a door of that vehicle is closed. Thus, the present invention seeks to provide a baffle that limits sound transfer, but which also allows a fluid such as air to flow through at least a portion of the baffle.

### SUMMARY OF THE INVENTION

The invention is directed to a baffle having a flow through medium. The baffle is typically designed for insertion into a cavity of a structure of an article of manufacture such as an automotive vehicle. Preferably, the baffle can limit sound passing through the baffle while still allowing a fluid such as air to flow therethrough. The flow through medium may be generally planar or may have other configurations as well and has an outer periphery. The flow through medium also includes a plurality of openings, which allow air to flow through the medium. An expandable material is preferably substantially coextensive with the outer periphery of the flow through medium and the expandable material is preferably activatable such that the expandable material can expand and adhere to walls of the structure of the article of manufacture.

### BRIEF DESCRIPTION OF THE DRAWINGS

The features and inventive aspects of the present invention will become more apparent upon reading the following detailed description, claims, and drawings, of which the following is a brief description:

FIG. 1 is an elevated view of a surface of a flow-through substrate according to one aspect of the present invention.

FIG. 2 is an elevated view of another surface of the flow-through substrate of FIG. 1.

FIG. 3 is a perspective view of a baffle in accordance with an aspect of the present invention.

FIG. 4 is a perspective view of an automotive vehicle having a baffle in accordance with an aspect of the present invention.

### DETAILED DESCRIPTION OF THE PREFERRED EMBODIMENT

The present invention is predicated upon providing a baffle having a medium that allows a fluid such as air to flow therethrough. The baffle has found particular utility for automotive vehicles although it is contemplated that the baffle may be applied to a variety of articles of manufacture such as airplanes, boats, buildings, furniture or the like.

Accordingly, the baffle of the present invention typically includes the following:

1) a flow-through medium that allow a fluid such as air to flow through it; and

2) an expandable material connected to the flow-through medium wherein the expandable material can typically be activated to flow, expand, foam or a combination thereof.

It is contemplated that the flow-through medium can be configured in a variety of shapes and sizes. As examples, the flow-through medium may be thick or thin, may be geometric or non-geometric, may be planar or non-planar or the like.

The flow-through medium typically includes at least one, but more typically a plurality of openings formed in the medium. Typically, the openings will be through-holes extending through a thickness of the medium from a first surface to a second surface of the medium. The thickness of the medium may be substantially continuous or variable and can be less than 2 decimeters, less than 1 decimeter, less than 5 centimeters or even less than 1 centimeter, but the thickness of the medium can be greater than 0.01 millimeter, greater than 0.05 millimeter, greater than 0.1 millimeter, greater than 1 centimeter and even greater than 2 centimeter.

Typically, the flow-through medium will have an outer periphery and the first and second surfaces of the flow-through medium will be at least partially or substantially entirely defined by the outer periphery. In such an embodiment, the first and second surfaces will typically have an average opening frequency, which is defined herein as the number of openings per square unit of surface area of the first or second surface. Average opening frequency may be calculated by selecting, for example, a three square centimeter area of either the first or second surface, determining how may openings are at least partially within the three square centimeter area and then dividing the number of openings by the three square centimeters to arrive at a value of number of openings per square centimeter.

The average opening frequency may be substantially the same or variable across a surface. However, it is contemplated that the average opening frequency can be consistently less than 400, less than 50, less than 20 or even less than 12 openings per square centimeter, but it is also contemplated that the opening frequency can be greater than 0.1, greater than 1, greater than 3, greater than 6 centimeter and even greater than 10 openings per square centimeter. It is also contemplated that opening frequencies may be greater or less than those discussed.

The actual openings for the flow-through medium can be relatively small or relatively large to provide relatively small or large pass-through areas. As used herein, pass-through areas are the smallest planar areas of the openings, as entirely defined by the flow-through medium, through which a fluid such as air can pass. Exemplary pass through areas can be greater than 0.01 mm², greater than 0.05 mm² and even greater than 0.5 mm² and can be less than 1 cm², more typically less than 0.5 cm² and even more typically less than 0.2 cm². It is also contemplated that pass-through areas may be greater or less than those discussed.

The pass-through medium may be made of a variety of different materials. Exemplary materials include plastics, polymeric materials, metals, foams, combinations thereof or the like such as steel, aluminum, nylon, molding compound, or the like.

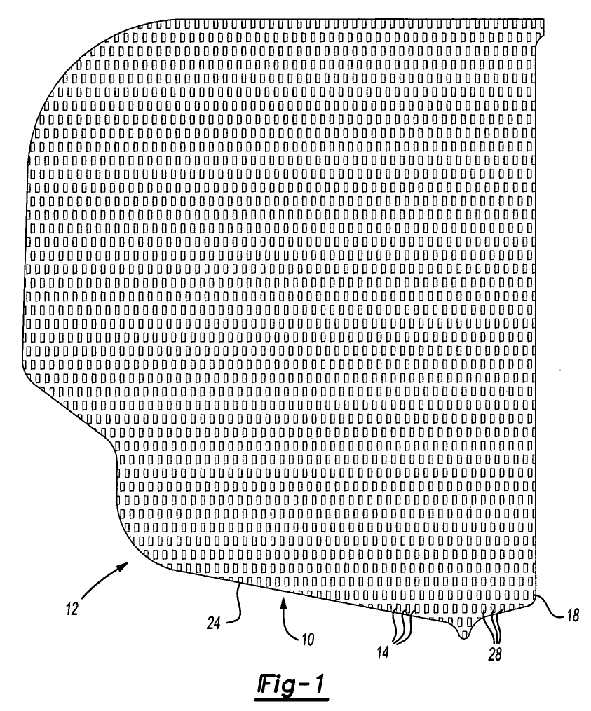

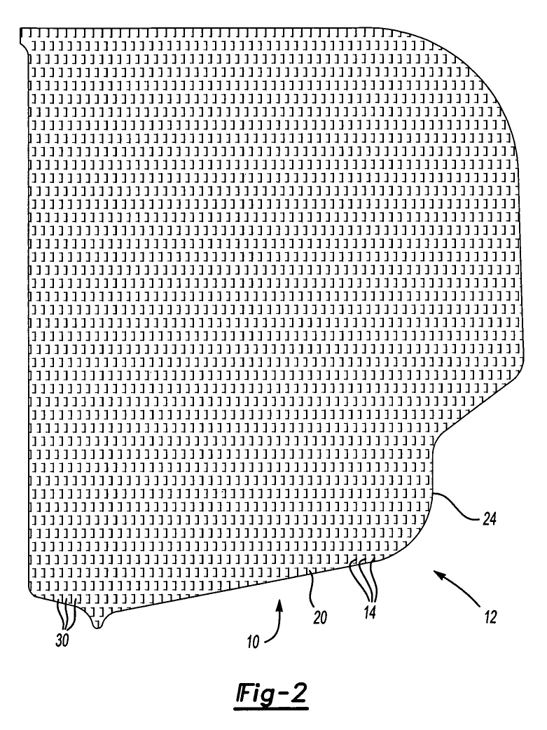

Referring to FIGS. 1-2, there is illustrated one exemplary embodiment of a flow-through medium 10 in accordance with the present invention. The medium is provided for purposes of illustration of the present invention. It is contemplated that alternatives to the medium 10 of FIGS. 1-2 may be employed in the practice of the present invention. Some of those alternatives are disclosed below, however, the skilled artisan will appreciate that other alternatives may also be employed as well in the practice of the present invention.

The flow-through medium 10 illustrated is a substantially planar metal panel 12 having a plurality of openings 14 extending therethrough. The panel 12 has a first generally planar surface 18 opposite a second generally planar surface 20 and the surfaces 18, 20 are substantially entirely defined by an outer periphery 24 or outer peripheral edge of the medium 10 or panel 12. Although only one panel is shown, it is contemplated that multiple panels may be layered or stacked or in opposing relation relative to each other and maybe spaced apart or contacting relation to each other.

In the embodiment illustrated, the openings 14 are through-holes that have been formed in the panel 12. In particular, the metal panel 12 is stamped such that protrusions 28 are formed in one surface 18 of the panel 12 and corresponding cavities 30 are formed in the other surface 20. Accordingly, adjacent the cavities 30, the metal panel 12 tears apart to form the openings 14 as slits extending through the panels 12. In the particular embodiment illustrated, the average opening frequency is about 9 openings per square centimeter.

Generally, the baffle of the present invention is formed by applying an expandable material to the flow-through medium so that the expandable material can be expanded and adhered to a structure of an article of manufacture for forming a baffling system. Typically, the expandable material is connected to the flow-through medium. The expandable material may be directly connected to the medium (e.g., directly adhered to the outer periphery of the medium). Alternatively, the expandable material may be indirectly connected to the medium (e.g., may be adhered to a member or housing that is attached to the medium).

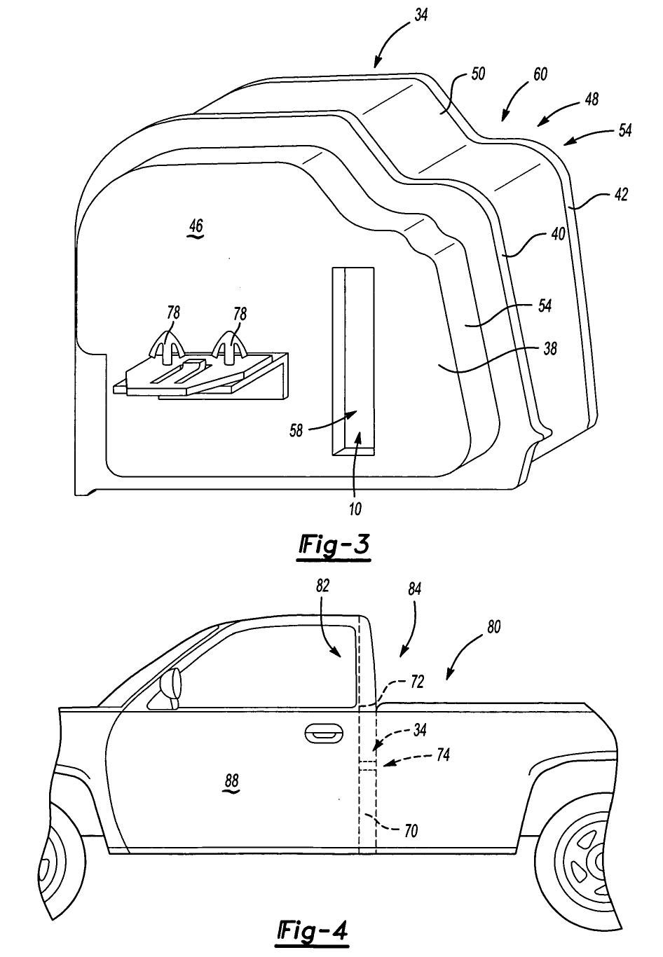

In FIG. 3, the flow through medium 10 of FIGS. 1 and 2 has been integrated into a baffle 34. The baffle 34 illustrated includes a housing 38 and a strip 40 of expandable material attached (e.g., adhered) to the housing 38, although multiple strips may be employed. The housing 38 includes a first wall 46 opposing a second wall 48 and a side wall 50 extending at least partially between peripheries 54 of the first and second walls 46, 48.

The flow-through medium 10 had been secured between the first wall 46 and the second wall 48. Moreover, a first opening 58 (e.g., through-hole) extends through the first wall 46 and a second opening 60 (e.g., through-hole) extends through the second wall 48 for providing fluid (e.g., air) communication to the flow-through medium 10.

In the embodiment shown, the side wall 50 and the peripheries 54 of the first wall 46 and the second wall 48 are substantially coextensive with the outer periphery 24 of the flow-through medium 10. Moreover, the first strip 40 of expandable material is respectively connected or attached (e.g., adhered) adjacent or directly to the outer periphery 54 of the first wall 46 and the second wall 48. As such, the strip 40 of expandable material is both adjacent to and substantially coextensive with the outer periphery 24 of the flow-through medium 10.

Various expandable materials may be employed in the present invention. Typically, the expandable material is a heat activated material having foamable characteristics. The material may be generally dry to the touch or tacky and can be placed upon or adjacent any of the components of the baffle in any form or desired pattern, placement, or thickness. Exemplary expandable materials include L-5248, L-7002 and L-5204 foams available through L&L Products, Inc. of Romeo, Mich.

Though other heat activated materials are possible for the expandable material, a preferred heat activated material is an expandable plastic, and preferably one that is foamable. Particularly preferred materials are an epoxy-based and EVA (Ethylene Vinyl Acetate) based structural, sealing, baffling or sound-absorbing foams. For example, and without limitation, the expandable material may be a structural or baffling foam that is an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of reinforcing, sealing and/or baffling foams are known in the art and may also be used to produce foam. A typical foam includes a polymeric base material, such as an epoxy resin, an ethylene-based polymer, an acrylate and/or acetate based material or a combination thereof which, when compounded with appropriate ingredients (typically a blowing and curing agent), expands and cures in a reliable and predictable manner upon the application of heat or the occurrence of a particular ambient condition. From a chemical standpoint for a thermally-activated material, the structural foam is usually initially processed as a flowable thermoplastic material before curing. Typically, the material will cross-link upon curing (e.g., become thermoset), which makes the material incapable of further flow under typical operating conditions of, for example, a frame or body of a vehicle.

Examples of preferred foam formulations are EVA based and epoxy-based materials that are commercially available from L&L Products of Romeo, Michigan, under the designations L5206, L5207, L5208, L5209, L5218, L5224, L-5248, XP321 and XP721. One advantage of the preferred foam materials over prior art materials is that the preferred materials can be processed in several ways. The preferred materials can be processed by injection molding, extrusion, compression molding, application with a mini-applicator, pelletization of the like. This enables the formation and creation of part designs that exceed the capability of most prior art materials. In one preferred embodiment, the structural foam (in its uncured state) is generally is dry or relatively free of tack to the touch.

While the preferred materials for fabricating the expandable material have been disclosed, the material can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, it is desirable for the expandable material to have good corrosion resistance properties. Still another desirable expandable material, which includes one or more acrylates, one or more acetates or a combination thereof is disclosed in U.S. provisional patent application Ser. No. 60/482,897 filed Jun. 26, 2003, incorporated herein by reference for all purposes.

In applications where the expandable material is a heat activated, thermally expanding material, an important consideration involved with the selection and formulation of the material comprising the foam is the temperature at which a material reaction or expansion, and possibly curing, will take place. For instance, in most applications, it is undesirable for the material to be reactive at room temperature or otherwise at the ambient temperature in a production line environment. More typically, the expandable material becomes reactive at higher processing temperatures, such as those encountered in an automobile assembly plant, when the foam is processed along with automobile components at elevated temperatures or at higher applied energy levels, e.g., during painting preparation steps. While temperatures encountered in an automobile assembly operation may be in the range of about 148.89° C. to 204.44° C. (about 300° F. to 400° F.), body and paint shop applications are commonly about 93.33° C. (about 200° F.) or higher. If needed, blowing agent activators can be incorporated into the composition to cause expansion at different temperatures outside the above ranges or expansion at different rates or to different degrees.

Generally, suitable expandable foams have a range of expansion ranging from approximately 0 to over 1000 percent. The level of expansion of the expandable material may be increased to as high as 1500 percent or more. In still other embodiments, it is contemplated that the expandable material expands to at least 2000%, 2500%, 3000% or more relative to its original non-expanded size. Typically, strength is obtained from products that possess low expansion while baffling and/or sound absorption is obtained through greater expansion.

In another embodiment, the expandable material is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

In addition, as discussed previously, preformed patterns may also be employed such as those made by extruding a sheet (having a flat or contoured surface) and then die cutting it according to a predetermined configuration in accordance with the chosen container or structure, and applying it thereto.

The skilled artisan will appreciate that the system may be employed in combination with or as a component of a vehicle structural reinforcement system, such as is disclosed in commonly owned co-pending U.S. application Ser. Nos. 09/524,961 or 09/502,686 (hereby incorporated by reference).

Assembly of the baffle (i.e., at least the flow-through medium with the expandable material) to a structure typically includes placement and/or securing of the baffle adjacent to the structure. After such assembly, the expandable material is activated to expand and, upon expansion, at least a portion of the expandable material contacts and wets one or more surfaces or walls of the structure. At the same time or upon cooling, the expandable material cures (e.g., thermosets) and adheres or attaches to the one or more surfaces or walls and secures the baffle and/or the flow-through medium in place.

In FIG. 3, the baffle 34 has been placed within a cavity 70 defined by one or more walls of an automotive pillar structure 72 to form a system 74. In the embodiment shown, the baffle 10 has been placed in the cavity 70 toward the bottom of the pillar structure 72 such that the top wall 46, the bottom wall 48, the flow-through medium 10, the panel 12 or a combination thereof are perpendicular or substantially perpendicular (i.e., within 30°, more preferably within 200, and even more preferably within 10° of perpendicular) relative to the one or more walls of the structure 72. Of course, it is contemplated that the baffle 34 can be otherwise arranged in the cavity.

The baffle 34 illustrated has been secured within the cavity 70 by interference fitting fasteners 78 to the pillar structure 72 defining the cavity 70. It is contemplated that various fasteners may be employed. For example, and without limitation, fasteners (e.g., screws, rivets, arrowhead fasteners, adhesives, magnets, interference fit fasteners, hooks, push-pins or others) may be employed to secure the baffle 10 in a desired location relative to the structure.

Upon activation, the strip 40 of expandable material expands and contacts the one or more walls of the structure 72. Upon cooling, the expandable material adheres to the walls thereby securing the baffle, the flow-through medium or both and the expandable material within the cavity 70. Typically, the expandable material, the flow-through medium 10 or both substantially span the entire cross-section of the cavity 70 to prevent passage of materials, particularly solid materials, therethrough, while typically still allowing passage of a fluid, particularly air therethrough.

Advantageously, the baffle 34 can be employed in a situation where it is desirable to inhibit the transmission of sound while still allowing the flow of a fluid such as air therethrough. For example, the pillar structure 72 of the vehicle 80 (e.g., the pick-up truck) in FIG. 4 remains in fluid communication with an interior cabin 82 (e.g., passenger compartment) of the vehicle 80 and in fluid communication with an ambient environment 84 surrounding the vehicle 80 (e.g., through openings in the pillar structure 72) particularly upon closing of a door 88 of the vehicle 80. Thus, upon closing of the door 88, air from the interior cabin 82 can flow to the ambient environment 84 thereby avoiding an undesirable elevated pressure within the cabin 82 of the vehicle 80.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A baffle for insertion into a cavity of a structure of an article of manufacture, comprising:
a generally planar flow through medium having an outer periphery and a plurality of openings, which allow air to flow through the medium; and
an expandable material that is substantially coextensive with the outer periphery of the medium, the expandable material being activatable such that the expandable material can expand and adhere to walls of the structure of the article of manufacture.

2. A baffle as in claim 1 wherein the flow through medium has an average opening frequency less than 50 but greater than 1 opening per square centimeter.

3. A baffle as in claim 1 wherein the flow through medium has an average opening frequency is less than 12 but greater than 6 openings per square centimeter.

4. A baffle as in claim 1 wherein each of the openings includes a flow-through area of less than about 0.2 square centimeters and greater than about 0.05 square millimeters

5. A baffle as in claim 1 wherein the article of manufacture is an automotive vehicle.

6. A baffle as in claim 5 wherein the baffle is located within the cavity of the structure such that the flow through medium is substantially perpendicular to the walls of the structure.

7. A baffle as in claim 6 wherein the flow through medium is within 10° of perpendicular to the walls of the structure.

8. A baffle as in claim 1 wherein the flow through medium is formed of a polymeric material, a metal, a foam or a combination thereof.

9. A baffle as in claim 1 wherein the flow through medium is a metal panel and the opening in the flow through medium are slits adjacent cavities formed in the metal panel.

10. A baffle as in claim 1 wherein the flow through medium includes multiple panels stacked in opposing relation to each other.

11. A baffle as in claim 1 wherein the flow through medium has a thickness that is less than 1 centimeter and greater than 0.05 millimeter.

12. A baffle as in claim 1 wherein the flow through medium is located within a housing that provides fluid communication to the flow through medium.

13. A baffle as in claim 1 wherein the baffle is located in the structure of the vehicle such that the structure is in fluid communication with a passenger compartment of the automotive vehicle and an ambient environment surrounding the vehicle.

14. A baffle for insertion into a cavity of a structure of an automotive vehicle, comprising:
A flow through medium having a plurality of openings, which allows air to flow through the medium wherein:
i) the flow through medium is formed of a substantially planar sheet having an outer periphery and a first surface opposite a second surface separated by a thickness;
ii) the first surface has a surface area of at least 0.5 decimeters and has an average opening frequency of at least 2 openings per square centimeter of said surface area; and
an expandable material connected to the medium, wherein:
i) the expandable material expands, foams, wets and adheres to walls of the cavity of the structure of the automotive vehicle upon exposure to elevated temperatures; and
ii) the expandable material is adjacent to and substantially coextensive with the outer periphery of the medium.

15. A baffle as in claim 14 wherein the baffle is located within the cavity of the structure such that the flow through medium is substantially perpendicular to the walls of the structure.

16. A baffle as in claim 14 wherein the flow through medium is formed of a polymeric material, a metal, a foam or a combination thereof.

17. A baffle as in claim 14 wherein the flow through medium is a metal panel and the opening in the flow through medium are slits adjacent cavities formed in the metal panel.

18. A baffle as in claim 14 wherein the flow through medium is located within a housing that provides fluid communication to the flow through medium.

19. A baffle as in claim 14 wherein the baffle is located in the structure of the vehicle such that the structure is in fluid communication with a passenger compartment of the automotive vehicle and an ambient environment surrounding the vehicle.

20. A baffle for insertion into a cavity of an automotive vehicle, comprising:
a medium having a plurality of openings, which allow air to flow through the medium wherein:
i) the medium is formed of a substantially planar metal sheet having an outer periphery and a first surface opposite a second surface separated by a thickness;
ii) the first surface has a surface area of at least 0.5 decimeters and has a density of openings of at least 2 openings per square centimeter of said surface area; and
iii) each of the openings includes a flow-through area of less than about 3 square millimeters and greater than about 0.2 square millimeters;
an expandable material connected to the medium, wherein:
i) the expandable material expands, foams, wets and adheres to walls of the cavity of the structure of the automotive vehicle upon exposure to elevated temperatures; and
ii) the expandable material is adjacent to and substantially coextensive with the outer periphery of the medium; and
a housing including a first wall with a first through-hole and a second wall with a second through-hole, wherein:
i) the flow through medium is between the first and second walls of the housing; and
ii) the first and second through-holes provide fluid communication with the flow through medium.
